(19) United States
(12) Patent Application Publication
(10) Pub. No.: US 2012/0218377 A1
(43) Pub. Date: Aug. 30, 2012

(54) IMAGE SENSING DEVICE

(75) Inventor: Tomoki OKU, Osaka (JP)

(73) Assignee: SANYO ELECTRIC CO., LTD., Osaka (JP)

(21) Appl. No.: 13/407,082

(22) Filed: Feb. 28, 2012

(30) Foreign Application Priority Data
Feb. 28, 2011 (JP) 2011-041961

(51) Int. Cl. H04N 5/262

(52) U.S. Cl. 348/36; 348/E05.051

(57) ABSTRACT

An image sensing device includes: an image sensing portion; a microphone portion; an image combination portion which combines a plurality of input images shot to generate a panorama image; a recording medium which records, together with an image signal of the panorama image, a sound signal based on an output of the microphone portion produced in a period during which the input images are shot; a reproduction control portion which updates and displays the panorama image on a display portion on an individual partial image basis so as to reproduce the entire panorama image; and a sound signal processing portion which generates, from the output of the microphone portion, a directional sound signal, in which, when the reproduction control portion reproduces the panorama image, the reproduction control portion simultaneously reproduces the directional sound signal.

### CROSS-REFERENCE TO RELATED APPLICATIONS

This nonprovisional application claims priority under 35 U.S.C. §119(a) on Patent Application No. 2011-041961 filed in Japan on Feb. 28, 2011, the entire contents of which are hereby incorporated by reference.

### BACKGROUND OF THE INVENTION

1. Field of the Invention

The present invention relates to image sensing devices such as a digital camera.

2. Description of Related Art

A method is known of shooting a plurality of still images while moving a camera in a left/right direction or in an up/down direction, of joining and combining the shot still images and of thereby forming a panorama image (a panorama picture) of a wide viewing angle.

Since a panorama image is not a moving image but one type of still image, when the panorama image is reproduced at the time of reproduction, a sound signal is not generally reproduced. However, there is an edition function of adding a sound note to the panorama image after a plurality of still images on which the panorama image is based are shot.

A system is also proposed that includes shooting means for shooting an image of an entire perimeter input by a reflective mirror and development means for changing the image input by the shooting means into a panorama image. In order to, for example, detect the direction of a sound source (the position of a speaker), the system records, together with an image, a sound signal at the time of the shooting of the image.

Since the sound note added after the shooting of the image is not related to sound around the camera at the time of the shooting of the image, even if the sound note is reproduced simultaneously with the panorama image, it is difficult for a viewer to acquire a sense of realism at the time of the shooting of the image.

### SUMMARY OF THE INVENTION

According to the present invention, there is provided an image sensing device including: an image sensing portion which shoots a subject within a shooting region; a microphone portion which is formed with a microphone; an image combination portion which combines a plurality of input images shot by the image sensing portion with the shooting regions different from each other so as to generate a panorama image; a recording medium which records, together with an image signal of the panorama image, a sound signal based on an output of the microphone portion produced in a period during which the input images are shot; a reproduction control portion which updates and displays the panorama image on a display portion on an individual partial image basis so as to reproduce the entire panorama image; and a sound signal processing portion which generates, from the output of the microphone portion, a directional sound signal that is a sound signal having directivity, in which, when the reproduction control portion reproduces the panorama image, the reproduction control portion simultaneously reproduces the directional sound signal as an output sound signal based on the sound signal recorded in the recording medium.

### BRIEF DESCRIPTION OF THE DRAWINGS

FIG. 1 is a schematic overall block diagram of an image sensing device according to an embodiment of the present invention;

FIG. 2 is a diagram showing the internal configuration of the image sensing portion of FIG. 1;

FIG. 3 is a diagram showing the microphone portion of FIG. 1 and a portion subsequent the microphone portion;

FIG. 4 shows an external perspective view of the image sensing device shown in FIG. 1;

FIGS. 5A and 5B are diagrams showing examples of the polar pattern of a sound signal that can be generated by directivity control; and FIG. 5C is a diagram illustrating the angle of a sound source;

FIG. 6 is a diagram showing a full view extending over the front of the image sensing device of FIG. 1;

FIG. 7 is a block diagram of portions that are involved in the generation of a panorama image;

FIG. 8 is a diagram showing a plurality of input images;

FIG. 9 is a diagram illustrating a shooting period of the input images;

FIG. 10 is a diagram showing a specific example of the input images;

FIGS. 11A and 11B are diagrams illustrating the effects of a panning operation;

FIG. 12A is a diagram showing an example of the panorama image; and FIG. 12B is a diagram showing an image within a left side region, an image within a center region and an image within a right side region in the panorama image;

FIG. 13 is a block diagram of portions that are involved in the generation of a link sound signal;

FIG. 14 is a diagram showing a reproduction control portion and a portion subsequent to the reproduction control portion;

FIG. 15 is a diagram illustrating a reproduction period of the panorama image;

FIG. 16 is a diagram showing how an extraction frame is set in the panorama image;

FIG. 17 is a diagram showing an example of a plurality of partial images extracted from the panorama image;

FIG. 18 is a diagram illustrating the significance of an enhancement target region;

FIGS. 19A to 19C are diagrams showing shooting regions and enhancement target regions corresponding to three times during the shooting period;

FIG. 20 is a diagram showing an example of display pictures and output sounds during the reproduction period;

FIG. 21 is a diagram showing how the reproduction period is divided into three equal parts;

FIGS. 22A to 22C are diagrams showing three areas corresponding to three division periods obtained by dividing the reproduction period into three equal parts;

FIG. 23A is a diagram showing an example of shooting images and input sounds during the shooting period; and FIG. 23B is a diagram showing an example of display pictures and output sounds during the reproduction period;

FIG. 24 is a diagram showing a moving image generation portion; and

FIG. 25 is a diagram showing the relationship between a microphone and an enclosure of the image sensing device.

### DETAILED DESCRIPTION OF PREFERRED EMBODIMENTS

Examples of an embodiment of the present invention will be specifically described below with reference to accompanying drawings. In the referenced drawings, like parts are identified with like symbols, and the description of the like parts will not be repeated in principle. In the present specification, for ease of description, signs or symbols representing information, a physical quantity, a state quantity, a member and the like are added, and thus the designations of the information, the physical quantity, the state quantity, the member and the like corresponding to the signs or the symbols may be omitted or described in short. For example, when an input image is represented by a sign I [1], the input image I[1] may be represented by, for example, the image I[1].

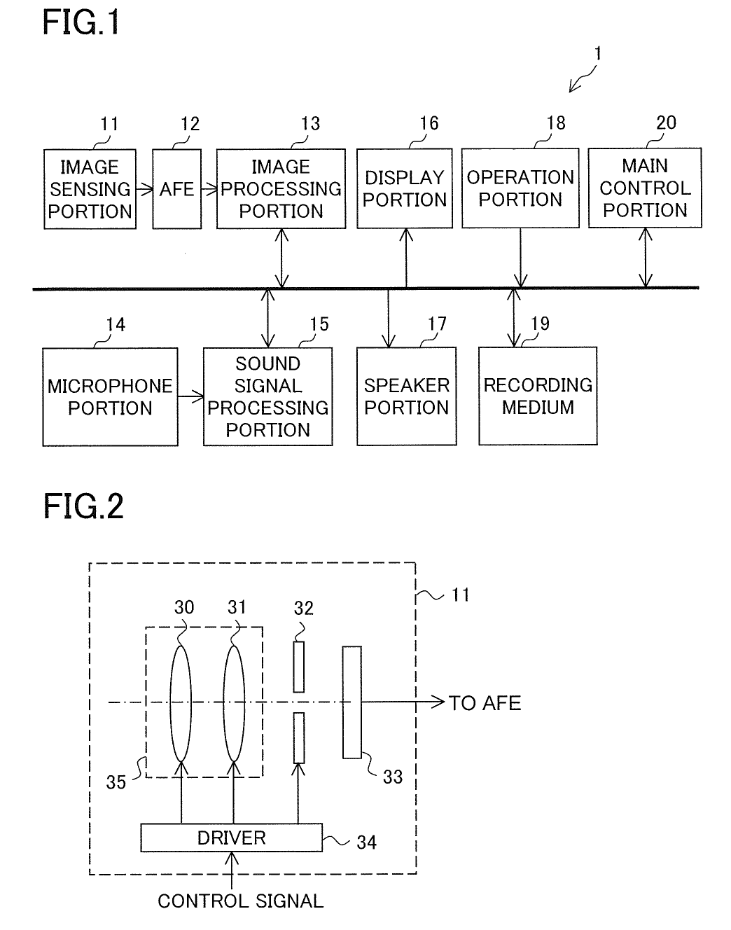

FIG. 1 is a schematic overall block diagram of an image sensing device 1 according to the embodiment of the present invention. The image sensing device 1 is either a digital still camera that can shoot and record a still image or a digital video camera that can shoot and record a still image and a moving image. The image sensing device 1 may be a device that is incorporated in a portable terminal such as a cellular telephone.

The image sensing device 1 includes an image sensing portion 11, an AFE (analog front end) 12, an image processing portion 13, a microphone portion 14, a sound signal processing portion 15, a display portion 16, a speaker portion 17, an operation portion 18, a recording medium 19 and a main control portion 20. The display portion 16 and the speaker portion 17 may be provided in an external reproduction device (not shown; such as a television receiver) that is different from the image sensing device 1.

FIG. 2 shows a diagram illustrating the internal configuration of the image sensing portion 11. The image sensing portion 11 includes an optical system 35, an aperture 32, an image sensor 33 that is formed with a CCD (charge coupled device), a CMOS (complementary metal oxide semiconductor) image sensor or the like and a driver 34 for driving and controlling the optical system 35 and the aperture 32. The optical system 35 is formed with a plurality of lenses including a zoom lens 30 and a focus lens 31. The zoom lens 30 and the focus lens 31 can be moved in the direction of an optical axis. The driver 34 drives and controls, based on a control signal from the main control portion 20, the positions of the zoom lens 30 and the focus lens 31 and the opening of the aperture 32, and thereby controls the focal distance (the angle of view) and the focal position of the image sensing portion 11 and the amount of light entering the image sensor 33 (in other words, an aperture value).

The image sensor 33 photoelectrically converts an optical image that enters the image sensor 33 through the optical system 35 and the aperture 32 and that represents a subject, and outputs an electrical signal obtained by the photoelectrical conversion to the AFE 12. The AFE 12 amplifies an analog signal output from the image sensing portion 11 (the image sensor 33), and converts the amplified analog signal into a digital signal. The AFE 12 outputs this digital signal as RAW data to the image processing portion 13. The amplification degree of the signal in the AFE 12 is controlled by the main control portion 20.

The image processing portion 13 generates, based on the RAW data from the AFE 12, an image signal indicating an image (hereinafter also referred to a shooting image) shot by the image sensing portion 11. The image signal generated here includes a brightness signal and a color-difference signal, for example. The RAW data itself is also one type of image signal; the analogue signal output from the image sensing portion 11 is also one type of image signal. In the present specification, the image signal of a certain image may be simply referred to an image. Hence, for example, the generation, the acquisition, the recording, the processing, the deformation, the edition or the storage of an input image means the generation, the acquisition, the recording, the processing, the deformation, the edition or the storage of the image signal of the input image.

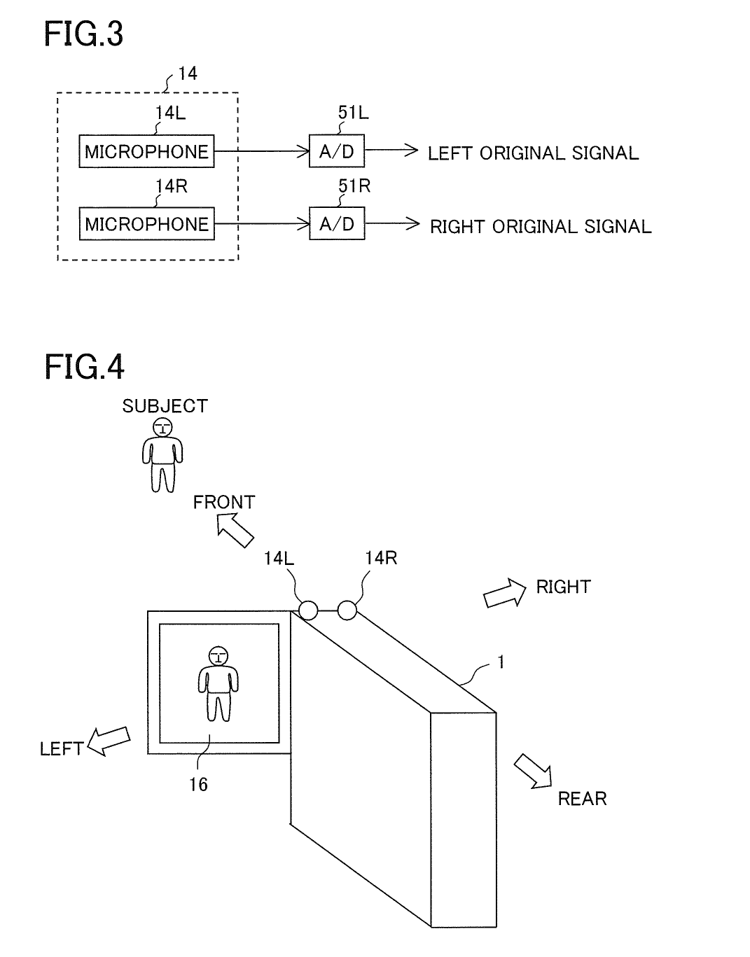

The microphone portion 14 convers an ambient sound of the image sensing device 1 into a sound signal. The microphone portion 14 can be formed with a plurality of microphones. Here, as shown in FIG. 3, the microphone portion 14 is assumed to be formed with two microphones 14L and 14R. A/D converters 51L and 51R can be provided in the sound signal processing portion 15. FIG. 4 shows an external perspective view of the image sensing device 1. The microphones 14L and 14R are arranged in different positions on an enclosure of the image sensing device 1. FIG. 4 also shows a subject of the image sensing device 1 that is an object to be shot by the image sensing device 1. The shooting image of the subject is displayed on the display portion 16, and thus a user can check the shooting region (in other words, the shooting range) of the image sensing device 1 and the like.

As shown in FIG. 4, a direction toward the subject that can be shot by the image sensing device 1 is defined as the front, and a direction opposite thereto is defined as the rear. The front and the rear are directions along the optical axis of the image sensing portion 11. The right and the left are assumed to mean the right and the left when seen from the rear side to the front side.

Each of the microphones 14L and 14R converts sound collected by itself into an analogue sound signal and outputs it. The A/D converters 51L and 51R of FIG. 3 respectively convert the analogue sound signals output from the microphones 14L and 14R into digital sound signals at a predetermined sampling period (for example, 48 kilohertz), and output them. The output signal of the A/D converter 51L is particularly referred to as a left original signal; the output signal of the A/D converter 51R is particularly referred to as a right original signal.

The sound signal processing portion 15 can perform sound signal processing necessary for the left original signal and the right original signal. The details of this processing will be described later.

The display portion 16 is a display device that has a display screen such as a liquid crystal display panel, and displays, under control of the main control portion 20, the shooting image, an image recorded in the recording medium 19 or the like. Unless otherwise specified in particular, the display and the display screen described in the present embodiment refer to display and a display screen on the display portion 16. The speaker portion 17 is formed with one or a plurality of speakers, and reproduces and outputs an arbitrary sound signal such a sound signal generated by the microphone portion 14, a sound signal generated by the sound signal processing portion 15 or a sound signal read from the recording medium 19. The operation portion 18 is formed with mechanical buttons, a touch panel or the like, and receives various operations from the user. The details of the operation performed on the operation portion 18 are transmitted to the main control portion 20 and the like. The recording medium 19 is a nonvolatile memory such as a card-shaped semiconductor memory or a magnetic disc, and stores the shooting image and the like under control of the main control portion 20. The main control portion 20 comprehensively controls the operations of individual portions of the image sensing device 1 according to the details of the operation performed on the operation portion 18.

The operation modes of the image sensing device 1 include a shooting mode in which a still image or a moving image can be shot and a reproduction mode in which a still image or a moving image recorded in the recording medium 19 can be reproduced on the display portion 16. In the shooting mode, the subject is periodically shot at a predetermined frame period, and the image sensing portion 11 (more specifically, the AFE 12) outputs the RAW data indicating a shooting image sequence of the subject. An image sequence of which the shooting image sequence is typical refers to a collection of still images arranged chronologically.

As the microphones 14L and 14R, nondirectional microphones, which have no directivity, can be employed. When the microphones 14L and 14R are nondirectional microphones, the left original signal and the right original signal are nondirectional sound signals (sound signals having no directivity). The sound signal processing portion 15 uses known directivity control, and thereby can generate, from the nondirectional left original signal and right original signal, a sound signal that has a directional axis in an arbitrary direction.

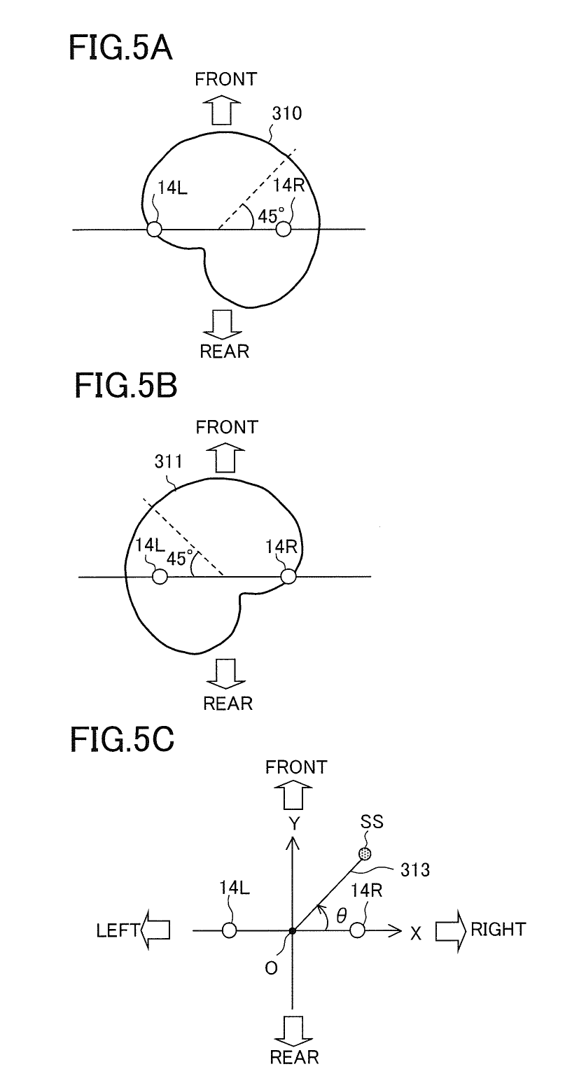

This directivity control can be realized by, for example, delay processing for delaying the left original signal or the right original signal, attenuation processing for attenuating only a predetermined proportion of the left original signal or the right original signal and subtraction processing for subtracting, from one of the left original signal and the right original signal that have been subjected to the delay processing and/or the attenuation processing, the other thereof. For example, by performing the directivity control on the left original signal and the right original signal, it is possible to generate a sound signal that has a polar pattern 310 of FIG. 5A, that is, a sound signal that has a dead area in a leftwardly-diagonal rearward direction of 45°. The sound signal having the polar pattern 310 is a sound signal that has a directional axis in a rightwardly-diagonal frontward direction of 45°, that is, a sound signal that has the highest directivity (sensitivity) with respect to a component of sound coming to the image sensing device 1 from a sound source that is located in the rightwardly-diagonal frontward direction of 45° with respect to the image sensing device 1. By contrast, for example, by performing the directivity control on the left original signal and the right original signal, it is possible to generate a sound signal that has a polar pattern 311 of FIG. 5B, that is, a sound signal that has a dead area in a rightwardly-diagonal rearward direction of 45°. The sound signal having the polar pattern 311 is a sound signal that has a directional axis in a leftwardly-diagonal frontward direction of 45°, that is, a sound signal that has the highest directivity (sensitivity) with respect to a component of sound coming to the image sensing device 1 from a sound source that is located in the leftwardly-diagonal frontward direction of 45° with respect to the image sensing device 1.

An X-Y coordinate plane (an X-Y coordinate system) as shown in FIG. 5C in which an X axis and a Y axis are coordinate axes is defined. The X axis is an axis that passes through the center of the microphone 14L and the center of the microphone 14R, and an origin O is located at the midpoint between these centers. The Y axis is perpendicular to the X axis at the origin O. A direction along the Y axis coincides with the direction of the optical axis (the optical axis of the image sensor 33) of the image sensing portion 11. The X axis and the Y axis are assumed to be parallel to a horizontal plane. The direction (that is, the rightward direction of the image sensing device 1) extending from the origin O to the microphone 14R is assumed to be the positive direction of the X axis; the direction extending from the origin O to the front of the image sensing device 1 is assumed to be the positive direction of the Y axis. A line segment 313 is a line segment that connects the origin O and a sound source SS which is an arbitrary sound source. An angle formed by the X axis and the line segment 313 is represented by θ. The angle θ is an angle between the X axis and the line segment 313 when the line segment 313 is seen in the counterclockwise direction from the line segment connecting the origin O and the center of the microphone 14R. The counterclockwise direction refers to a direction in which the line segment extending from the origin O to the center of the microphone 14R is rotated toward the front side of the image sensing device 1. The angle θ of the sound source SS indicates a direction (that is, a sound source direction with respect to the sound source SS) toward the position of the sound source SS.

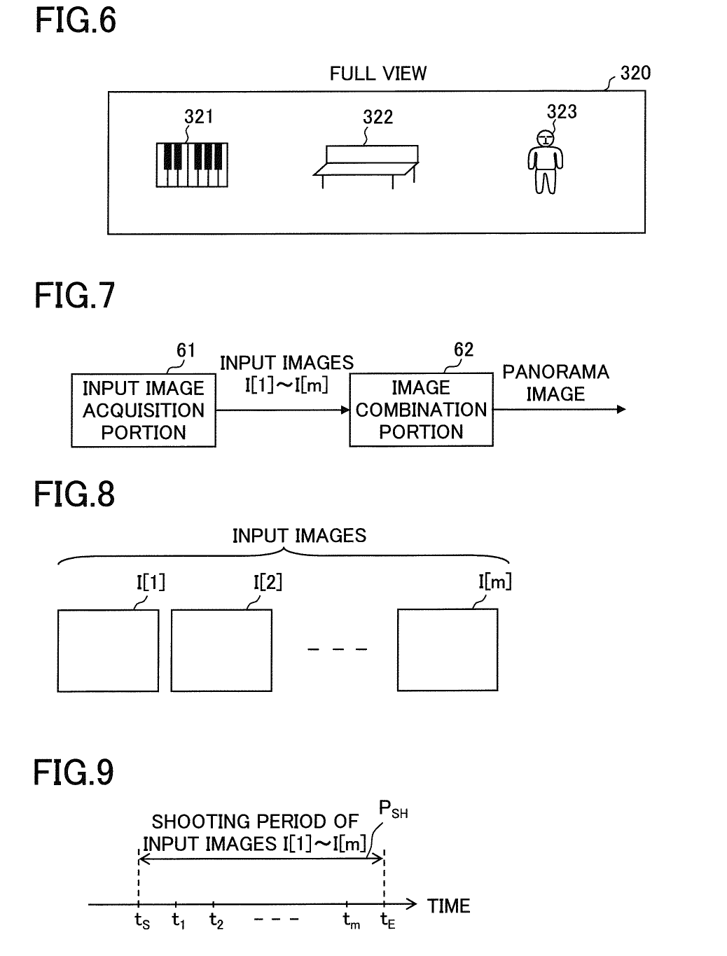

FIG. 6 shows a full view on the front side of the image sensing device 1 that is assumed in the present embodiment. A picture within a solid frame represented by symbol 320 is the full view extending over the front of the image sensing device 1. As seen from the image sensing device 1, subjects 321, 322 and 323 are respectively present on the left side of the full view 320, in the vicinity of the center of the full view 320 and on the right side of the full view 320. The subjects 321, 322 and 323 are a musical instrument, a chair and a person, respectively. The subject 321, which is the musical instrument, and the subject 323, who is the person, have a function as a sound source that produces sound. On the other hand, the subject 322, which is the chair, does not have a function as a sound source.

Although the entire full view 320 cannot be placed within the shooting angle of view at one time, the user is assumed to want to acquire an image of the entire full view 320. The shooting angle of view refers to the angle of view in the shooting performed with the image sensing portion 11. The image sensing device 1 has the function of generating a panorama image of the full view 320 from a plurality of shooting images obtained while waving the image sensing device 1.

FIG. 7 shows a block diagram showing portions that are involved in the generation of the panorama image. An input image acquisition portion 61 and an image combination portion 62 can be provided in the image processing portion 13 of FIG. 1.

The input image acquisition portion 61 acquires a plurality of input images based on the output signal of the image sensing portion 11. The image sensing portion 11 shoots subjects within the shooting region either periodically or intermittently, and thereby can acquire a shooting image sequence of the subjects; the image sensing portion 11 acquires this shooting image sequence as the input images. The input images are still images (that is, the shooting images of the subjects) that are obtained by shooting the subjects within the shooting region with the image sensing portion 11. The shooting region refers to a region on an actual space that is placed within the view of the image sensing portion 11. The input image acquisition portion 61 receives the output signal of the AFE 12 directly from the AFE 12, and thereby can acquire the input images. Alternatively, in the shooting mode, the shooting images of the subjects are first recorded in the recording medium 19, and thereafter, in the reproduction mode, the shooting images of the subjects read from the recording medium 19 are fed to the input image acquisition portion 61, with the result that the input image acquisition portion 61 may acquire the input images.

As shown in FIG. 8, a plurality of input images are represented by signs I[1] to I[m] (m is an integer of two or more). The shooting angle of view at the time of the shooting of the input images is assumed to remain constant between the input images I[1] to I[m]. As shown in FIG. 9, the shooting period of the input images I[1] to I[m] is represented by sign P_{SH}. The shooting period P_{SH} is a period from a time t_{S} to a time t_{E}. The user performs a predetermined operation on the operation portion 18, and thereby can provide an instruction of the start and completion of the shooting period P_{SH} (that is, the user can specify the time t_{S} and the time t_{E}). Times t₁ to tₘ arranged chronologically belong to the shooting period P_{SH}. A time tᵢ is the shooting time of the input image I[i] (i is an integer). More specifically, for example, the time t, is the start time, the center time or the completion time of an exposure period of the image sensor 33 for obtaining the image signal of the input image I[i] from the image sensor 33. A time tᵢ₊₁ is a time behind the time tᵢ. The time t₁ and the time tₘ may agree with the time t_{S} and the time t_{E}, respectively; alternatively, the time t_{S} may be a predetermined time period ahead of the time t₁, and the time t_{E} may be a predetermined time period behind the time tₘ.

For example, m sheets of shooting images obtained while performing a panning operation on the image sensing device 1 are acquired as the input images I[1] to I[m]. More specifically, for example, the user presses, at the time t_{S}, a shutter button (not shown) provided in the operation portion 18 with the subject 321 placed within the shooting region, and thereafter performs the panning operation on the image sensing device 1 with the shutter button held pressed such that the subject within the shooting region is sequentially shifted from the subject 321 to the subject 322 and then to the subject 323. Then, when the subject 323 is placed in the vicinity of the center of the shooting region, the operation of pressing the shutter button is cancelled. The time when the cancellation is performed corresponds to the time t_{E}. While the shutter button is being pressed, the image sensing portion 11 periodically and repeatedly shoots the subjects, and thus a plurality of shooting images (the shooting images of the subjects) arranged chronologically are obtained. The input image acquisition portion 61 can obtain the shooting images as the input images I[1] to I[m].

Alternatively, for example, each of the times t₁ to tₘ may be specified by the user. In this case, the user presses, one at a time, the shutter button at each of the times t₁, t₂, . . . and tₘ while performing the panning operation on the image sensing device 1 such that the subject within the shooting region is sequentially shifted from the subject 321 to the subject 322 and then to the subject 323.

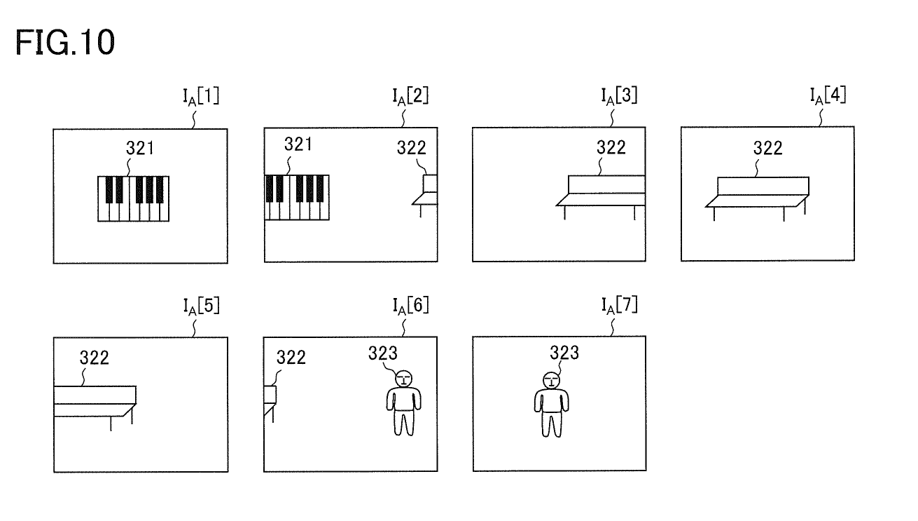

FIG. 10 shows input images I_{A}[1] to I_{A}[7] as an example of the input images I[1] to I[m]. In the example of FIG. 10, m=7. When i and j are different integers, the shooting region at the time of the shooting of the input image I[i] and the shooting region at the time of the shooting of the input image I[j] are different from each other. Among the subjects 321 to 323, when the input image I_{A}[1] is shot, only the subject 321 is placed within the shooting region; when the input image I_{A}[4] is shot, only the subject 322 is placed within the shooting region; and, when the input image 1471 is shot, only the subject 323 is placed within the shooting region.

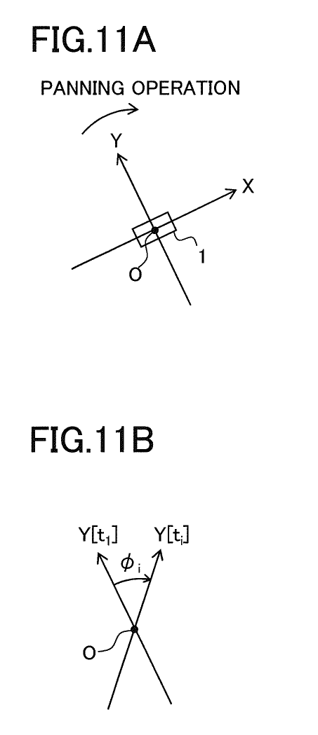

The panning operation performed on the image sensing device 1 during the shooting period P_{SH} corresponds to, as shown in FIG. 11A, an operation of rotating the image sensing device 1 in a horizontal direction, using a vertical line passing through the origin O (also see FIG. 5C) as a rotational axis; in the panning operation, the Y axis corresponding to the optical axis of the image sensing portion 11 is rotated on the horizontal plane. The Y axis at the time tᵢ is now represented by Y[tᵢ], and, as shown in FIG. 11B, an angle formed by the Y axis (that is, the Y[t₁]) at the time tᵢ and the Y axis (that is, the Y[tᵢ]) at the time tᵢ is represented by φᵢ. φ₁ is 0°. Here, it is assumed that as the variable i is increased, the angle Φᵢ is monotonically increased. When the input images I_{A}[1] to I_{A}[7] are shot, the formula “0°=Φ₁<Φ₂<Φ₃<Φ₄<Φ₅<Φ₆<Φ₇<360°” holds true.

The image combination portion 62 of FIG. 7 combines a plurality of input images, that is, the input images I[1] to I[m], that are shot by the image sensing portion 11 with the shooting regions different from each other, and thereby generates a panorama image (combination resulting image). The angle of view of the panorama image is larger than each of the input images I[1] to I[m]. The image combination portion 62 joins and combines the input images I[1] to I[m] such that the common subjects of the input images I[1] to I[m] overlap each other, and thereby generates the panorama image. The combination described above is commonly referred to as image mosaicing; known image mosaicing can be utilized in the image combination processing performed by the image combination portion 62.

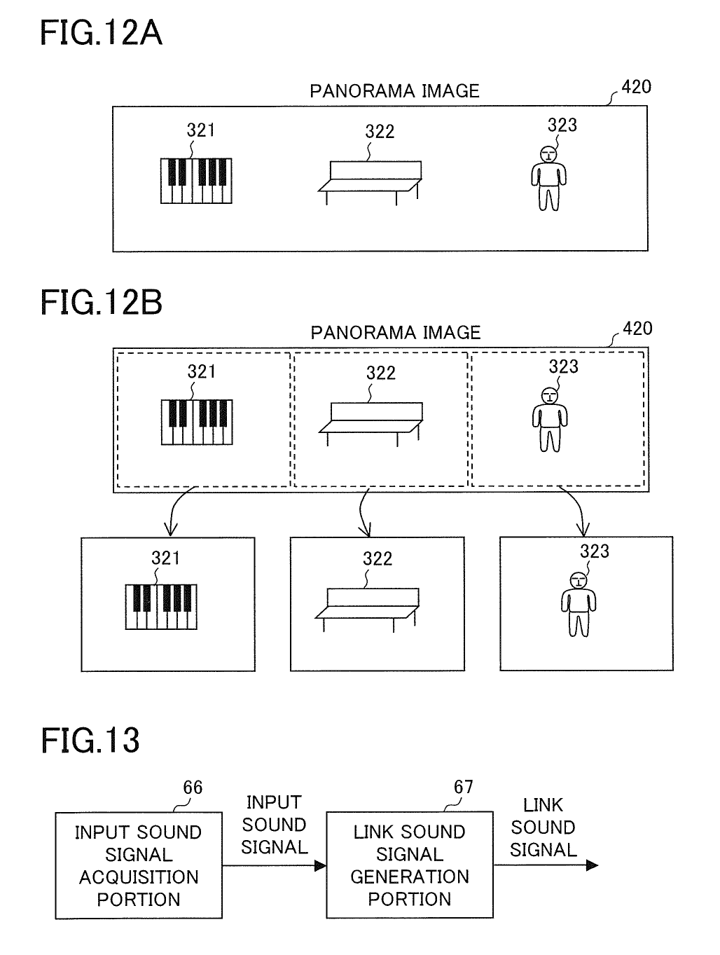

An image 420 of FIG. 12A shows an example of the panorama image based on the input images I_{A}[1] to I_{A}[7]. When the entire image region of the panorama image 420 is divided into three equal parts that are a left side region, a center region and a right side region, for example, as shown in FIG. 12B, the image within the left side region, the image within the center region and the image within the right side region correspond to the input images I_{A}[1], I_{A}[4] and I_{A}[7] of FIG. 10, respectively.

It is possible to generate the panorama image at an arbitrary timing after the acquisition of the input images I[1] to I[m]. Hence, for example, the panorama image may be generated in the shooting mode immediately after the acquisition of the input images I[1] to I[m] in the shooting mode. Alternatively, the input images I[1] to I[m] may be recorded in the recording medium 19 in the shooting mode, and thereafter the panorama image may be generated based on the input images I[1] to I[m] read from the recording medium 19 in the reproduction mode. The image signal of the panorama image generated in the shooting mode or in the reproduction mode can be recorded in the recording medium 19.

On the other hand, the image sensing device 1 has the function of recording and generating a sound signal that can be reproduced together with the panorama image. FIG. 13 is a block diagram of portions that are particularly involved in realizing this function. An input sound signal acquisition portion 66 and a link sound signal generation portion 67 can be provided in the sound signal processing portion 15 of FIG. 1.

The input sound signal acquisition portion 66 acquires an input sound signal, and outputs it to the link sound signal generation portion 67. The input sound signal is composed of the left original signal and the right original signal during the shooting period P_{SH}. The link sound signal generation portion 67 generates, from the input sound signal, a link sound signal, which should be said to be an output sound signal (the details of the link sound signal will be described later).

It is possible to generate the link sound signal at an arbitrary timing after the acquisition of the input sound signal. Hence, for example, the link sound signal may be generated in the shooting mode immediately after the acquisition of the input sound signal in the shooting mode. Alternatively, the input sound signal may be recorded in the recording medium 19 in the shooting mode, and thereafter the link sound signal may be generated based on the input sound signal read from the recording medium 19 in the reproduction mode. The link sound signal generated in the shooting mode or in the reproduction mode can be recorded in the recording medium 19.

The image signal of the input images I[1] to I[m] is associated with the input sound signal or the link sound signal, and they can be recorded in the recording medium 19; the image signal of the panorama image is associated with the input sound signal or the link sound signal, and they can be recorded in the recording medium 19. For example, when the link sound signal and the panorama image are generated in the shooting mode, with the link sound signal associated with the panorama image, the link sound signal is preferably recorded together with the panorama image in the recording medium 19. Moreover, preferably, for example, when the link sound signal and the panorama image are generated in the reproduction mode, with the input sound signal associated with the input images I[1] to I[m] in the shooting mode, they are recorded in the recording medium 19, and the input sound signal and the input images I[1] to I[m] are read from the recording medium 19 in the reproduction mode and the link sound signal and the panorama image are generated from the input sound signal and the input images I[1] to I[m] that have been read. The link sound signal and the panorama image that are generated in the reproduction mode can also be recorded in the recording medium 19.

The image sensing device 1 can reproduce the panorama image in a characteristic manner. The method of reproducing the panorama image and the method of utilizing the panorama image, based on the configuration and the operation described above, will be described in first to third examples below. Unless a contradiction arises, a plurality of examples can also be combined together.

### FIRST EXAMPLE

The first example will be described. In the first example, the operation of the image sensing device 1 in a panorama reproduction mode that is one type of reproduction mode will be described. In the first example and the second and third examples described later, in order to give a specific description, it is assumed that, as the input images I[1] to I[m], the input images I_{A}[1] to I_{A}[7] of FIG. 10 are obtained, and that, based on the input images I_{A}[1] to I_{A}[7], the panorama image 420 of FIG. 12A is obtained.

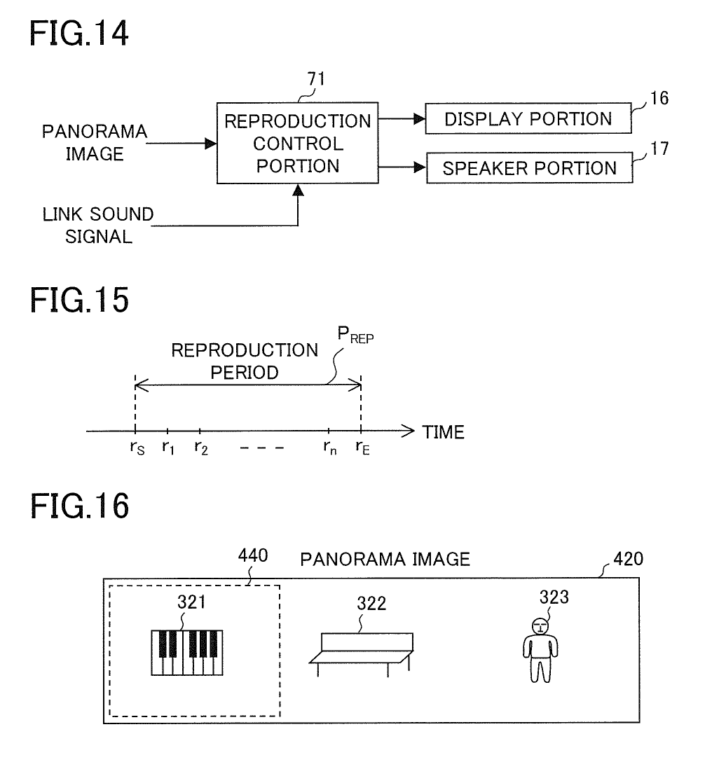

A reproduction control portion 71 of FIG. 14 can be realized by the image processing portion 13 or the main control portion 20 of FIG. 1, or can be realized by a combination of the image processing portion 13 and the main control portion 20. The reproduction control portion 71 controls the reproduction of the panorama image 420. The image signal of the panorama image 420 and the link sound signal are input to the reproduction control portion 71. The link sound signal generation portion 67 of FIG. 13 may be provided within the reproduction control portion 71, and the link sound signal may be generated within the reproduction control portion 71.

The operation of the panorama reproduction mode will be described with reference to FIGS. 15 and 16 and the like. The entire panorama image 420 is reproduced for a reproduction period P_{REP} that is a predetermined period of time. As shown in FIG. 15, the start time and the completion time of the reproduction period P_{REP} are represented by r_{S} and r_{E}, respectively. Times (reproduction times) r₁ to rₙ arranged chronologically belong to the reproduction period P_{REP} (n is an integer of two or more). A time rᵢ₊₁ is a time behind the time rᵢ. The time rᵢ and the time rₙ may agree with the time r_{S} and the time r_{E}, respectively; alternatively, the time r_{S} may be a predetermined time period ahead of the time r₁, and the time r_{E} may be a predetermined time period behind the time rₙ.

The reproduction of the panorama image 420 by the reproduction control portion 71 is referred to as slide reproduction. In the slide reproduction, as shown in FIG. 16, the reproduction control portion 71 sets an extraction frame 440 within the panorama image 420, and, during the reproduction period P_{REP}, the image within the extraction frame 440 is updated and displayed on the display portion 16 while the extraction frame 440 is being moved on the panorama image 420. The extraction frame 440 is a rectangular frame; the aspect ratio of the extraction frame 440 can be made equal to the aspect ratio of the display screen of the display portion 16. Here, for ease of description, the aspect ratio and the angle of view of the extraction frame 440 are assumed to be equal to the aspect ratio and the angle of view of each of the input images. The left edge of the extraction frame 440 at the time r₁ coincides with the left edge of the panorama image 420 whereas the right edge of the extraction frame 440 at the time rₙ coincides with the right edge of the panorama image 420; the direction of movement of the extraction frame 440 during the reproduction period P_{REP} is a direction that extends from the left edge to the right edge of the panorama image 420. Hence, in a simple example, an image (hereinafter referred to as a display image) displayed on the display portion 16 at the time rᵢ coincides with the input image I_{A}N. The extraction frame 440 is moved every small number of pixels (for example, every few pixels to few tens of pixels), the display image is updated every time the extraction frame 440 is moved and thus it is possible to obtain smooth picture change. By the update and the display described above, the entire panorama image 420 is reproduced for the reproduction period P_{REP}.

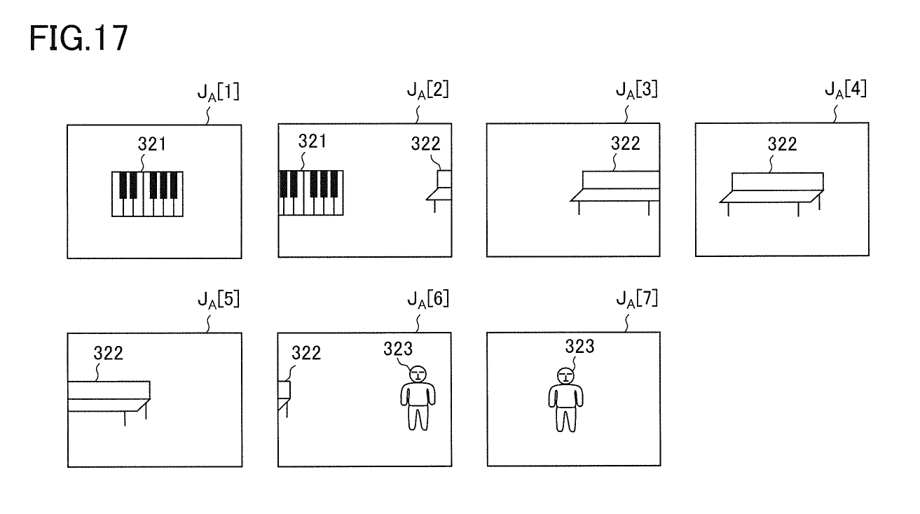

An image within the extraction frame 440 at each time during the reproduction period P_{REP} is referred to as a partial image; an image within the extraction frame 440 at the time rᵢ is referred to as an i-th partial image. Then, while, at the times r₁, r₂, . . . and rₙ, the reproduction control portion 71 sequentially updates the first partial image, the second partial image, . . . and the n-th partial image, the reproduction control portion 71 displays them as the display image on the display portion 16. Each of the first to n-th partial images is part of the panorama image 420; the first to n-th partial images are different from each other. The images J_{A}[1] to J_{A}[7] of FIG. 17 are examples of the first to seventh partial images, respectively. The i-th partial image J_{A}[i] of FIG. 17 is the same image as the input image I_{A}[i] of FIG. 10.

When the reproduction control portion 71 uses the display portion 16 to perform, as described above, the slide reproduction on the panorama image 420, the reproduction control portion 71 uses the speaker portion 17 to simultaneously reproduce the link sound signal based on the sound signal recorded in the recording medium 19. As understood from the above description, the sound signal recorded in the recording medium 19 can be the link sound signal itself.

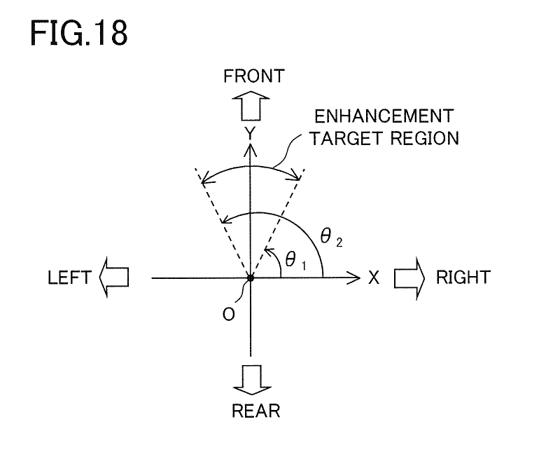

The link sound signal generation portion 67 (see FIG. 13) uses the directivity control to generate, from the input sound signal, a directional sound signal that is a sound signal having directivity, and can output the directional sound signal as the link sound signal. As shown in FIG. 18 (also see FIG. 5C), a region on the actual space where the sound source SS satisfying θ₁≦θ≦θ₂ is arranged is referred to an enhancement target region. Then, specifically, it is preferable to generate a directional sound signal that has a higher sensitivity on sound from the sound source SS arranged within the enhancement target region than a sensitivity on sound from the sound source SS arranged outside the enhancement target region. In other words, it is preferable to generate a directional sound signal that has a directional axis in a direction toward the position of the sound source SS within the enhancement target region. θ₁ and θ₂ satisfy 0°≦θ₁<90°<θ₂≦180°. Furthermore, θ₁ and θ₂ may also satisfy 90°−θ₁=θ₂−90°, and typically, for example, an angle (θ₂−0₁) may be made equal to the shooting angle of view of the image sensing portion 11. In the following description, the angle (θ₂−θ₁) is assumed to be equal to the shooting angle of view of the image sensing portion 11.

The link sound signal may be either a stereo signal (for example, a stereo signal composed of a sound signal having the polar pattern 310 of FIG. 5A and a sound signal having the polar pattern 311 of FIG. 5B) or a monaural signal.

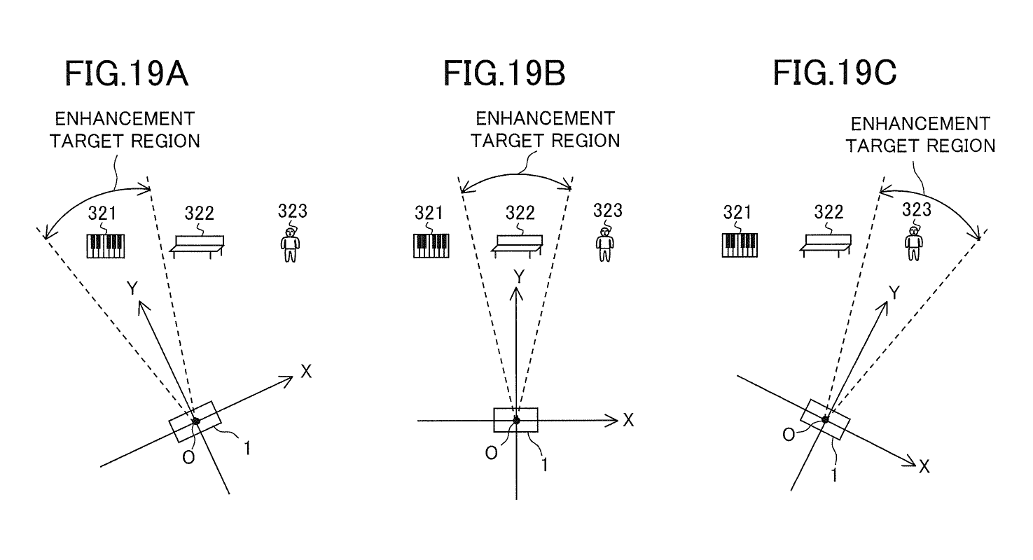

As the Y axis is rotated by the panning operation during the shooting period P_{SH} (see FIGS. 11A and 11B), the enhancement target region is also changed during the shooting period P_{SH}. For example, as shown in FIG. 19A, at the time tᵢ during the shooting period P_{SH}, among the subjects 321 to 323, only the subject 321 is placed within the shooting region and is also placed in the enhancement target region; as shown in FIG. 19B, at the time t₄ during the shooting period P_{SH}, among the subjects 321 to 323, only the subject 322 is placed within the shooting region and is also placed in the enhancement target region; as shown in FIG. 19C, at the time t₇ during the shooting period P_{SH}, among the subjects 321 to 323, only the subject 323 is placed within the shooting region and is also placed in the enhancement target region.

The length of the reproduction period P_{REP} (more specifically, for example, the time length between the time r₁ and the time rₙ) is preferably made equal to the length of a recording time of the sound signal, that is, the length of the shooting period P_{SH} (more specifically, for example, the time length between the time t₁ and the time tₙ); it is preferable to determine the speed of movement of the extraction frame 440 so as to realize the equalization described above. When the length of the reproduction period P_{REP} is made equal to the length of the recording time of the sound signal (the length of the shooting period P_{SH}), the link sound signal corresponding to the length of the shooting period P_{SH} based on the left original signal and the right original signal during the shooting period P_{SH} is reproduced during the reproduction period P_{REP}.

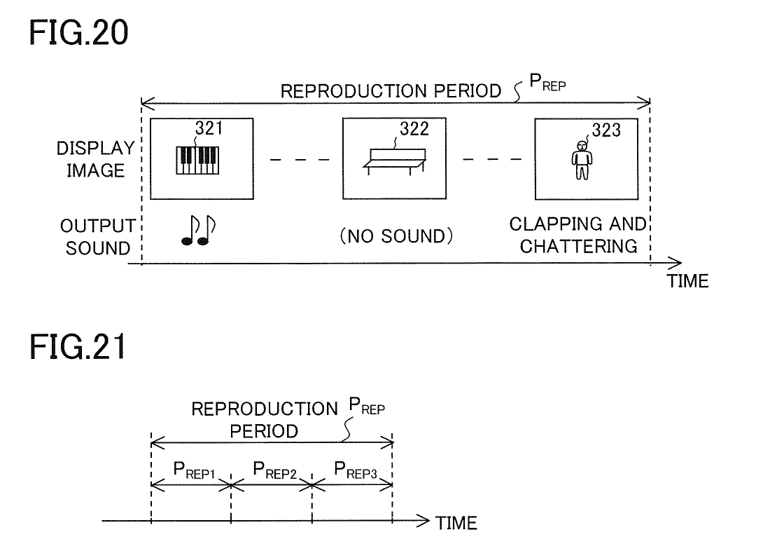

In the slide reproduction described above, for example, as shown in FIG. 20, music by the musical instrument 321 is first reproduced together with the reproduction of the picture of the musical instrument 321, and, as the display image is moved to the right side of the full view 320 (as the extraction frame 440 is moved to the right side of the panorama image 420), the voice of the person 323 who is a spectator or the sound of clapping is reproduced.

In the directivity control on the input sound signal, a signal component of sound coming from a specific direction, of the input sound signal is enhanced more than the other signal components, and the enhanced input sound signal is generated as the directional sound signal. Hence, the reproduction method in the first example can be expressed as follows (this expression can also be applied to the second example described later). At a timing when the subject (musical instrument) 321 serving as a sound source is displayed during the reproduction period P_{REP}, as compared with the sound from the subject 323 that is not displayed, the sound from the subject 321 is enhanced and output from the speaker portion 17 whereas, at a timing when the subject (person) 323 serving as a sound source is displayed during the reproduction period P_{REP}, as compared with the sound from the subject 321 that is not displayed, the sound from the subject 323 is enhanced and output from the speaker portion 17.

Alternatively, the reproduction method in the first example can be expressed as follows (this expression can also be applied to the second example described later). When the i-th partial image including the image signal of a sound source is displayed during the reproduction period P_{REP} (here, i is an integer equal to or more than 1 but equal to or less than n), sound from a sound source shown in the i-th partial image is enhanced and output from the speaker portion 17. Specifically, for example, when the partial image J_{A}[1] of FIG. 17 is displayed at the time r₁, as compared with sound (that is, sound produced by the person) from the subject 323 that is not shown in partial image J_{A}[1], sound (that is, sound produced by the musical instrument) from the subject 321 shown in the partial image J_{A}[1] is enhanced and output from the speaker portion 17 whereas, when the partial image J_{A}[7] of FIG. 17 is displayed at the time r₇, as compared with the sound (that is, the sound produced by the musical instrument) from the subject 321 that is not shown in the partial image J_{A}[7], the sound (that is, the sound produced by the person) from the subject 323 shown in the partial image J_{A}[7] is enhanced and output from the speaker portion 17.

In the first example, when the panorama image, which should be said to be a panorama picture, is reproduced, it is possible to reproduce the sound signal corresponding to the display picture, and thus it is possible to reproduce the panorama image having a sense of realism.

### SECOND EXAMPLE

The second example will be described. The second example and the third example described later are examples based on the first example; with respect to what is not particularly described in the second and third examples, unless a contradiction arises, the description of the first example can be applied to the second and third examples. In the second example, the operation of the image sensing device 1 in the panorama reproduction mode will also be described.

In the second example, the reproduction period P_{REP} is divided into a plurality of periods. Here, in order to give a specific description, it is assumed that, as shown in FIG. 21, the reproduction period P_{REP} is equally divided into three division periods P_{REP1}, P_{REP2} and P_{REP3}. The division period P_{REP2} is a period behind the division period P_{REP1}; the division period P_{REP3} is a period behind the division period P_{REP2}.

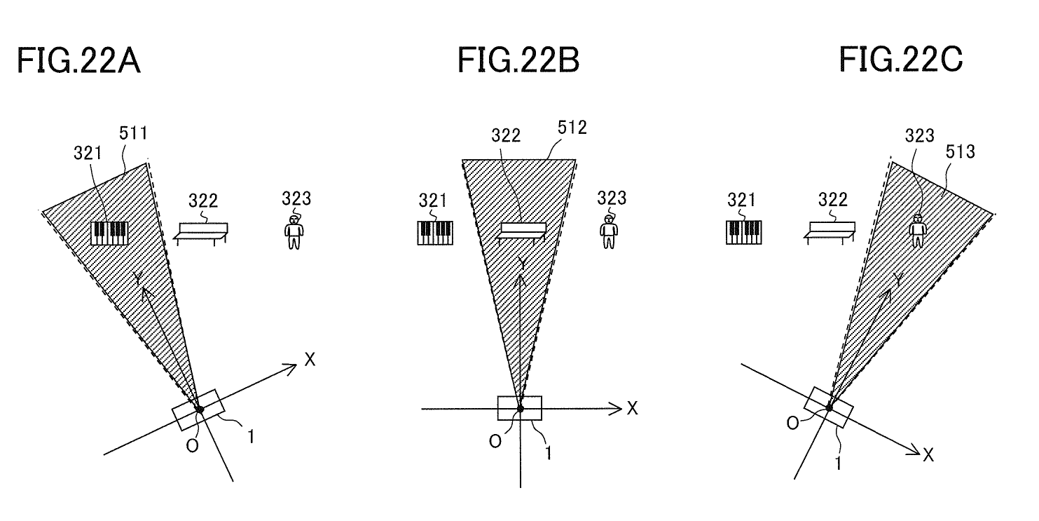

The method of performing the slide reproduction on the panorama image 420 is the same as described in the first example. Hence, in the early part of the reproduction period P_{REP}, the subject 321 is displayed, in the center part of the reproduction period P_{REP}, the subject 322 is displayed and, in the late part of the reproduction period P_{REP}, the subject 323 is displayed (see FIG. 20). The late part of the reproduction period P_{REP} is a part behind the early part of the reproduction period P_{REP} in terms of time; the center part of the reproduction period P_{REP} is a part between the early part of the reproduction period P_{REP} and the late part of the reproduction period P_{REP}. Here, it is assumed that, during the division period P_{REP1}, the subject within an area 511 of FIG. 22A is displayed, that, during the division period P_{REP2}, the subject within an area 512 of FIG. 22B is displayed and that, during the division period P_{REP3,} the subject within an area 513 of FIG. 22C is displayed. The diagonally shaded regions of FIGS. 22A to 22C correspond to the areas 511 to 513, respectively. Among the subjects 321 to 323, only the subject 321 is present within the area 511, only the subject 322 is present within the area 512 and only the subject 323 is present within the area 513.

The area 511 is an area that is placed within the shooting region of the image sensing portion 11 in a period of shooting (that is, in the early part of the shooting period P_{SH}) corresponding to the division period P_{REP1}; the area 512 is an area that is placed within the shooting region of the image sensing portion 11 in a period of shooting (that is, in the center part of the shooting period P_{SH}) corresponding to the division period P_{REP2}, the area 513 is an area that is placed within the shooting region of the image sensing portion 11 in a period of shooting (that is, in the late part of the shooting period PO corresponding to the division period P_{REP3}. The late part of the shooting period P_{SH} is a part behind the early part of the shooting period P_{SH} in terms of time; the center part of the shooting period P_{SH} is a part between the early part of the shooting period P_{SH} and the late part of the shooting period P_{SH}.

The link sound signal generation portion 67 of FIG. 13 uses the directivity control and thereby extracts, from the entire input sound signal during the shooting period P_{SH}, a sound signal from a sound source present within the area 511, as a first direction signal. Likewise, the generation portion 67 uses the directivity control and thereby extracts, from the entire input sound signal during the shooting period P_{SH}, a sound signal from a sound source present within the area 512, as a second direction signal, and also uses the directivity control and thereby extracts, from the entire input sound signal during the shooting period P_{SH}, a sound signal from a sound source present within the area 513, as a third direction signal. The first to third direction signals are included in the link sound signal.

When the reproduction control portion 71 of FIG. 14 performs the slide reproduction on the panorama image 420, the reproduction control portion 71 reproduces the first direction signal at the speaker portion 17 in the division period P_{REP1} during which the subject 321 is displayed, reproduces the second direction signal at the speaker portion 17 in the division period P_{REP2} during which the subject 322 is displayed and reproduces the third direction signal at the speaker portion 17 in the division period P_{REP3} during which the subject 323 is displayed.

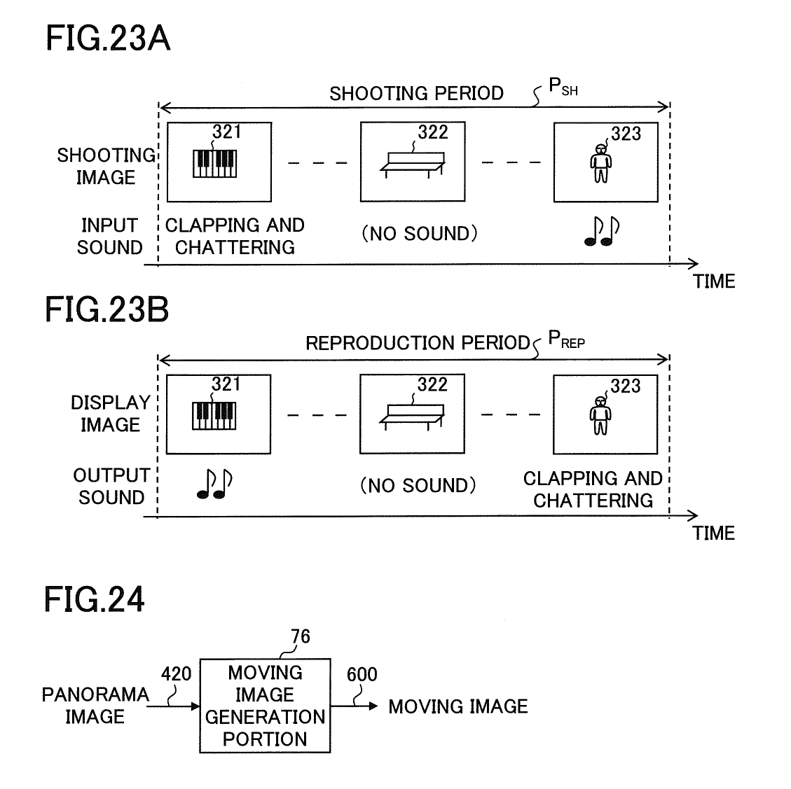

A specific example of the reproduction operation according to the method discussed above will be described with reference to FIGS. 23A and 23B. During the shooting period P_{SH}, the subject placed within the shooting region is sequentially shifted from the subject 321 to the subject 322 and then to the subject 323 by the panning operation described above. In this case, it is assumed that, as shown in FIG. 23A, the sound from the subject 323 serving as the person is produced only in the early part of the shooting period P_{SH}, and that the sound from the subject 321 serving as the musical instrument is produced only in the late part of the shooting period P_{SH}. The sound from the subject 323 and the sound from the subject 321 are acquired as the input sound signal.

When the input sound signal described above is acquired, the sound signal (that is, the sound signal of the sound produced by the musical instrument 321) from the sound source present within the area 511 is extracted, as the first direction signal, by the directivity control, from the input sound signal in the late part of the shooting period P_{SH}, and the sound signal (that is, the sound signal of the sound produced by the person 323) from the sound source present within the area 513 is extracted, as the third direction signal, by the directivity control, from the input sound signal in the early part of the shooting period P_{SH}. Then, when the slide reproduction is performed on the panorama image 420, as shown in FIG. 23B, in the division period P_{REP1} during which the musical instrument 321 is displayed, the first direction signal (that is, the sound signal of the sound produced by the musical instrument 321) is reproduced by the speaker portion 17, and, in the division period P_{REPS} during which the person 323 is displayed, the third direction signal (that is, the sound signal of the sound produced by the person 323) is reproduced by the speaker portion 17.

As described above, the Y axis corresponding to the optical axis of the image sensing portion 11 is rotated during the shooting period P_{SH}, and, accordingly, the X axis (see FIG. 5C) where the microphones 14L and 14R are arranged is also rotated. Thus, in order to extract each of the direction signals, it is necessary to find the positional relationship between the Y axis and the areas 511 to 513 at each time during the shooting period P_{SH}. The link sound signal generation portion 67 can find the positional relationship from angular speed sensor information obtained during the shooting period P_{SH}. Specifically, by the directivity control using the angular speed sensor information (the angular speed sensor information obtained during the shooting period P_{SH}), it is possible to extract each of the direction signals from the input sound signal. The angular speed sensor information can be associated with the input sound signal and be recorded in the recording medium 19 so that each of the direction signals can be generated at an arbitrary timing.

The angular speed sensor (unillustrated) and an angular detection portion (unillustrated) that detect the angular speed of the enclosure of the image sensing device 1 can be provided in the image sensing device 1. The angular speed sensor can detect at least the angular speed in the panning operation, that is, the angular speed of the enclosure of the image sensing device 1 when the Y axis is rotated on the horizontal plane, using a vertical line passing through the origin O as the rotational axis (see FIGS. 11A and 11B). The angular speed sensor information indicates the result of the detection by the angular speed sensor. The angular detection portion can determine, based on the angular speed sensor information, an angle φᵢ at an arbitrary time during the shooting period P_{SH}. The generation portion 67 uses the angle Φᵢ determined by the angular detection portion, and thereby can extract each of the direction signals.

As in the first example, when the slide reproduction is performed on the panorama image 420 using the display portion 16, the reproduction control portion 71 uses the speaker portion 17 and thereby simultaneously reproduces the link sound signal based on the sound signal recorded in the recording medium 19. The first to third direction signals included in the link sound signal are one type of directional sound signal generated from the input sound signal using the directivity control. As described above, in the directivity control on the input sound signal, a signal component of sound coming from a specific direction, of the input sound signal is enhanced more than the other signal components, and the enhanced input sound signal is generated as the directional sound signal. In the first, second and third direction signals, the sounds from the subjects present in the areas 511, 512 and 513, respectively, are enhanced (in the second example, it is assumed that the subject in the area 512 produces no sound).

As in the first example, in the second example, when the panorama image, which should be said to be a panorama picture, is reproduced, it is possible to reproduce the sound signal corresponding to the display picture, and thus it is possible to reproduce the panorama image having a sense of realism.

### THIRD EXAMPLE

The third example will be described. In the slide reproduction according to the first and second examples described above, the first partial image, the second partial image, . . . and the n-th partial image of the panorama image 420 are sequentially displayed on the display portion 16 as display images. Although such slide reproduction can be performed in the image sensing device 1 originally capable of slide reproduction or in a device incorporating special software for slide reproduction, it is difficult for a general-purpose device such as a personal computer to perform such slide reproduction.

Hence, in the third example, a moving image composed of the first to n-th partial images is generated. FIG. 24 shows a moving image generation portion 76 that can be provided in the image processing portion 13 or the main control portion 20 of FIG. 1.

The moving image generation portion 76 extracts, from the panorama image 420, the first to n-th partial images as n sheets of still images, and generates a moving image 600 composed of the n sheets of still images (that is, the first to n-th partial images). The moving image 600 is a moving image that has the first to n-th partial images as the first to n-th frames. The image sensing device 1 can record, in the recording medium 19, the image signal of the moving image 600 in an image file format for moving image. The moving image generation portion 76 can determine the image size of the first to n-th partial images such that the image size of each frame of the moving image 600 becomes a desired image side (for example, a VGA size having a resolution of 640×480 pixels).

The image sensing device 1 may associate the image signal of the moving image 600 with the link sound signal and record them in the recording medium 19. Specifically, for example, the image sensing device 1 may generate a moving image file in which the image signal of the moving image 600 and the link sound signal are stored and record the moving image file in the recording medium 19. It is possible to associate the link sound signal described in the first or second example with the moving image 600 and record them in the recording medium 19. When the moving image file described above is given to an arbitrary electronic device (for example, a portable information terminal, a personal computer or a television receiver) that can reproduce a moving image together with a sound signal, on the electronic device, the moving image 600 is reproduced together with the link sound signal, and thus the same picture and sound as described in the first or second example are simultaneously reproduced.

### Variations and the Like

In the embodiment of the present invention, many modifications are possible as appropriate within the scope of the technical spirit shown in the scope of claims. The embodiment described above is simply an example of the embodiment of the present invention; the present invention or the significance of tennis of constituent requirements is not limited to what has been described in the embodiment discussed above. The specific values indicated in the above description are simply illustrative; naturally, they can be changed to various values. Explanatory notes 1 to 5 will be described below as explanatory matters that can be applied to the embodiment described above. The subject matters of the explanatory notes can freely be combined together unless a contradiction arises.

### Explanatory Note 1

Although, in the embodiment described above, it is assumed that the number of microphones which constitute the microphone portion 14 is two, three or more microphones arranged in different positions may constitute the microphone portion 14.

### Explanatory Note 2

Alternatively, in the first example described above, the microphone portion 14 may be formed with only a single directional microphone having directivity. A configuration and an operation in the first example when the microphone portion 14 is formed with only a single directional microphone will be described. In this case, for example, the microphone 14R is omitted from the microphone portion 14 of FIG. 3, and the directional microphone is used as the microphone 14L. Among left original signals based on the output of the microphone 14L serving the directional microphone, the left original signal during the shooting period P_{SH} is acquired as the input sound signal by the input sound signal acquisition portion 66 (see FIG. 13). The microphone 14L serving as the directional microphone is also referred to as a directional microphone 14L.

For example (see FIG. 18), the directional microphone 14L has a higher sensitivity on sound from the sound source SS arranged within the enhancement target region than the sensitivity on sound from the sound source SS arranged outside the enhancement target region (that is, has a directional axis in the direction toward the position of the sound source SS within the enhancement target region). Then, the link sound signal generation portion 67 of FIG. 13 can generate, as the link sound signal, the input sound signal itself (that is, the left original signal itself during the shooting period P_{SH}) based on the output of the directional microphone 14L, and thus it is possible to reproduce the sound signal as in the first example. Specifically, for example, the link sound signal corresponding to the length of the shooting period P_{SH} based on the left original signal (the output sound signal of the directional microphone 14L) during the shooting period P_{SH} is reproduced in the reproduction period P_{REP}, and thus it is possible to perform the same image reproduction and sound signal reproduction as shown in FIG. 20.

### Explanatory Note 3

Alternatively, in the first example described above, the microphone portion 14 may be formed with only a single nondirectional microphone (omnidirectional microphone) having no directivity. A configuration and an operation in the first example when the microphone portion 14 is formed with only a single nondirectional microphone will be described. In this case, for example, the microphone 14R is omitted from the microphone portion 14 of FIG. 3, and the nondirectional microphone is used as the microphone 14L. Among left original signals based on the output of the microphone 14L serving as the nondirectional microphone, the left original signal during the shooting period P_{SH} is acquired as the input sound signal by the input sound signal acquisition portion 66 (see FIG. 13). The microphone 14L serving as the nondirectional microphone is also referred to as a nondirectional microphone 14L.

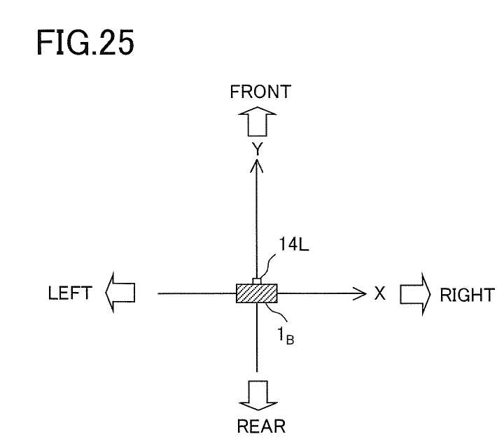

FIG. 25 shows an example of the positional relationship between the nondirectional microphone 14L and the enclosure I_{B} of the image sensing device 1 when the microphone portion 14 is formed with only the nondirectional microphone 14L. In the example of FIG. 25, since the enclosure I_{B} is arranged behind the nondirectional microphone 14L, sound coming from behind the image sensing device 1 is blocked by the enclosure I_{B}, and thus it is difficult for the nondirectional microphone 14L to catch the sound. Consequently, the nondirectional microphone 14L operates together with the enclosure I_{B}, and thus has the function equivalent to a directional microphone.

Specifically, for example, the nondirectional microphone 14L operates together with the enclosure I_{B}, and practically has a higher sensitivity on sound from the sound source SS arranged within the enhancement target region than the sensitivity on sound from the sound source SS arranged outside the enhancement target region (that is, has a directional axis in the direction toward the position of the sound source SS within the enhancement target region). Then, the link sound signal generation portion 67 of FIG. 13 can generate, as the link sound signal, the input sound signal itself (that is, the left original signal itself during the shooting period P_{SH}) based on the output of the nondirectional microphone 14L, and thus it is possible to perform the same sound signal reproduction as in the first example. Specifically, for example, the link sound signal corresponding to the length of the shooting period P_{SH} based on the left original signal (the output sound signal of the nondirectional microphone 14L) during the shooting period P_{SH} is reproduced in the reproduction period P_{REP}, and thus it is possible to perform the same image reproduction and sound signal reproduction as shown in FIG. 20.

As shown in FIG. 4, when the entire enclosure of the image sensing device 1 is formed by joining a first enclosure that is the enclosure of the display portion 16 to a second enclosure that is the enclosure of the members other than the display portion 16, the enclosure I_{B} may be the first enclosure. When the microphones 14L and 14R are included in the microphone portion 14, the microphones 14L and 14R may be provided in the first enclosure, though this situation is different from that shown in FIG. 4.

### Explanatory Note 4

The movement of the image sensing device 1 is referred to as a camera movement. Although, in the embodiment described above, as an example of the camera movement during the shooting period P_{SH}, the rotational movement by the panning operation is described, the camera movement during the shooting period P_{SH} can include not only the rotational movement by the palming operation but also a rotational movement by a tilt operation and a parallel movement in an arbitrary direction.

### Explanatory Note 5

The image sensing device 1 of FIG. 1 can be formed with hardware or a combination of hardware and software. When the image sensing device 1 is formed with software, the block diagram of a portion realized by the software represents a functional block diagram of the portion. The function realized by the software may be described as a program, and, by executing the program on a program execution device (for example, a computer), the function may be realized.

What is claimed is:

1. An image sensing device comprising:
an image sensing portion which shoots a subject within a shooting region;
a microphone portion which is formed with a microphone;
an image combination portion which combines a plurality of input images shot by the image sensing portion with the shooting regions different from each other so as to generate a panorama image;
a recording medium which records, together with an image signal of the panorama image, a sound signal based on an output of the microphone portion produced in a period during which the input images are shot;
a reproduction control portion which updates and displays the panorama image on a display portion on an individual partial image basis so as to reproduce the entire panorama image; and
a sound signal processing portion which generates, from the output of the microphone portion, a directional sound signal that is a sound signal having directivity,
wherein, when the reproduction control portion reproduces the panorama image, the reproduction control portion simultaneously reproduces the directional sound signal as an output sound signal based on the sound signal recorded in the recording medium.

2. The image sensing device of claim 1,
wherein the subject within the shooting region includes a subject functioning as a sound source, and
when the sound source is displayed on the display portion during a reproduction period, the sound signal processing portion generates the directional sound signal such that sound from the sound source is enhanced and reproduced.

3. The image sensing device of claim 1,
wherein a reproduction period is composed of a first reproduction time, a second reproduction time, . . . , and an n-th reproduction time arranged chronologically (n is an integer of two or more),
the reproduction control portion sequentially updates and displays a first partial image, a second partial image, . . . , and an n-th partial image of the panorama image on the display portion at the first reproduction time, the second reproduction time, . . . , and the n-th reproduction time,
the first to n-th partial images are different from each other and
when an i-th partial image is displayed on the display portion during the reproduction period (i is an integer equal to or more than one but equal to less than n), the sound signal processing portion generates the directional sound signal such that sound coming from a sound source shown in the i-th partial image is enhanced and reproduced.

4. The image sensing device of claim 1, further comprising:
a moving image generation portion which extracts, as n sheets of still images, from the panorama image, a first partial image, a second partial image, . . . , and an n-th partial image of the panorama image, and which generates a moving image composed of the n sheets of still images (n is an integer of two or more),
wherein the moving image is recorded in the recording medium, and the first to n-th partial images are different from each other.

5. The image sensing device of claim 4,
wherein, when the moving image is recorded in the recording medium, the output sound signal is also associated with the moving image and is recorded in the recording medium.
